(19) United States
(12) Patent Application Publication
(10) Pub. No.: US 2010/0085276 A1
(43) Pub. Date: Apr. 8, 2010

(54) HOLOGRAPHIC IMAGE DISPLAY SYSTEMS

(75) Inventor: Adrian Cable, Cambridge (GB)

Correspondence Address: KNOBBE MARTENS OLSON & BEAR LLP, 2040 MAIN STREET, FOURTEENTH FLOOR, IRVINE, CA, 92614, US

(73) Assignee: LIGHT BLUE OPTICS LTD., Cambridge, Cambridgeshire (UK)

(21) Appl. No.: 12/519,355

(22) PCT Filed: Dec. 12, 2007
(86) PCT No.: PCT/GB2007/050754

§ 371 Date: Dec. 15, 2009

(30) Foreign Application Priority Data
Dec. 21, 2006 (GB) 0625408.0

(51) Int. Cl. G09G 5/00

(52) U.S. Cl. 345/6

(57) ABSTRACT

This disclosure relates to methods, apparatus, and computer program code for the holographic display of images. We describe a method of displaying an image holographically. The method includes: dividing the image into a plurality of spatial tiles; and displaying, for each tile in rapid succession, at least one hologram to reproduce an image of the tile, to give the impression of the plurality of tiles together; and wherein the method also includes controlling a shutter spatial light modulator (SLM) in a replay field of the holograms such that when each tile is displayed light for the others of the plurality of tiles is substantially blocked.

### FIELD OF THE INVENTION

This invention relates to methods, apparatus, and computer program code for the holographic display of images.

### BACKGROUND TO THE INVENTION

Many small, portable consumer electronic devices incorporate a graphical image display, generally a LCD (Liquid Crystal Display) screen. These include digital cameras, mobile phones, personal digital assistants/organisers, portable music devices such as the iPOD (trade mark), portable video devices, laptop computers and the like. In many cases it would be advantageous to be able to provide a larger and/or projected image but to date this has not been possible, primarily because of the size of the optical system needed for such a display.

We have previous described, for example in WO 2005/059660, a method for image projection and display using appropriately calculated computer generated holograms displayed upon dynamically addressable liquid crystal (LC) spatial light modulators (SLMs). Broadly speaking in this technique an image is displayed by displaying a plurality of holograms each of which spatially overlaps in the replay field and each of which, when viewed individually, would appear relatively noisy because noise is added (by phase modulation) prior to a holographic transform of the image data. However when viewed in rapid succession the replay field images average together in the eye of a viewer to give the impression of a reduced (low) noise image. The noise in successive temporal subframes may either be pseudo-random (substantially independent) or the noise in a subframe may be dependent on the noise in one or more earlier subframes with the aim of at least partially cancelling this out, or a combination of both may be employed. More details of such OSPR-type procedures are described later.

FIG. 1 shows an example a consumer electronic device 10 incorporating a holographic image projection module 12 to project a displayed image 14. Displayed image 14 comprises a plurality of holographically generated sub-images each of the same spatial extent as displayed image 14, and displayed rapidly in succession so as to give the appearance of the displayed image. Each holographic sub-frame is generated using an OSPR-type procedure.

FIG. 2a shows an example optical system for the holographic projection module of FIG. 1. Referring to FIG. 2a, a laser diode 20 (for example, at 532 nm), provides substantially collimated light 22 to a spatial light modulator (SLM) 24 such as a pixellated liquid crystal modulator. The SLM 24 phase modulates light 22 with a hologram and the phase modulated light is preferably provided to a demagnifying optical system 26. In the illustrated embodiment, optical system 26 comprises a pair of lenses 28, 30 with respective focal lengths f₁, f₂, f₁<f₂, spaced apart at distance f₁+f₂. Optical system 26 increases the size of the projected holographic image by diverging the light forming the displayed image; it effectively reduces the pixel size of the modulator, thus increasing the diffraction angle. Lenses L₁ and L₂ form a beam-expansion pair which expands the beam from the light source so that it covers the whole surface of the modulator; depending on the relative size of the beam 22 and SLM 24 this may be omitted. A filter may be included to filter out unwanted parts of the displayed image, for example a zero order undiffracted spot or a repeated first order (conjugate) image, which may appear as an upside down version of the displayed image, depending upon how the hologram for displaying the image is generated.

An example of a suitable binary phase SLM is the SXGA (1280 1024) reflective binary phase modulating ferroelectric liquid crystal SLM made by CRL Opto (Forth Dimension Displays Limited, of Scotland, UK). A ferroelectric liquid crystal SLM is advantageous because of its fast switching time; binary phase devices are convenient but devices with three or more quantized phases may also be employed (use of more than binary phase enables the conjugate image to be suppressed, see WO 2005/059660).

A single optical arrangement can be used for beam expansion prior to modulation, and for demagnification of the modulated light. Thus the lens pair L1 and L2 and the lens pair L3 and L4 may comprise at least part of a common optical system, used in reverse, in conjunction with a reflective SLM, for light incident on and reflected from the SLM.

FIG. 2b illustrates such a lens sharing arrangement, in which a polariser is included to suppress interference between light travelling in different directions, that is into and out of the SLM. FIG. 2c shows, schematically, a preferred practical configuration of such a system, in which the laser diode (LD) does not obscure a central portion of the replay field. In the arrangement of FIG. 2c a polarising beam splitter is used to direct the output, modulated light at 90 degrees on the image plane, and also to provide the function of the polariser in FIG. 2b.

A colour holographic projection system may be constructed by employing an optical system as described above to create three optical channels, red, blue and green superimposed to generate a colour image. In practice this is difficult because the different colour images must be aligned on the screen and a better approach is to create a combined red, green and blue beam and provide this to a common SLM and demagnifying optics. In this case, however, the different colour images are of different sizes; techniques to address this are described in our co-pending UK patent application no. GB0610784.1 filed 2 Jun. 2006, hereby incorporated by reference.

Referring again to FIG. 2a, a digital signal processor 100 has an input 102 to receive image data from the consumer electronic device defining the image to be displayed. The DSP 100 implements an OSPR-type procedure to generate phase hologram data for a plurality of holographic sub-frames which is provided from an output 104 of the DSP 100 to the SLM 24, optionally via a driver integrated circuit if needed. The DSP 100 drives SLM 24 to project a plurality of phase hologram sub-frames which combine to give the impression of displayed image 14 in the replay field (RPF). The DSP 100 may comprise dedicated hardware and/or Flash or other read-only memory storing processor control code to implement the hologram generation procedure.

In the optical arrangements of each of FIGS. 2a-2c an intermediate image is formed between lenses L3 and L4 of the demagnification optics, at which the replay field (which is reproduced there) may be spatially filtered.

OSPR-type techniques substantially reduce the amount of computation required for a high quality holographic image display and the temporal averaging reduces the level of perceived noise, which is dominated by noise variance. However there are other parameters which are also important for practical holographic image display systems. In particular these include contrast ratio, which can effectively be represented by signal-to-noise ratio (SNR), and uniformity, which can be represented by signal energy variance (approximately, noise in the light parts of the image). The inventors have identified techniques which address these issues; moreover these are not restricted to OSPR-type procedures for hologram calculation.

Background prior art is described in Computer, August 2005, pages 46 to 53, Slinger et al, “Computer-Generated Holography as a Generic Display Technology”, GB2350963 A, and GB2350962 A.

### SUMMARY OF THE INVENTION

According to a first aspect of the invention there is therefore provided a method of displaying an image holographically, the method comprising: dividing said image into a plurality of spatial tiles; and displaying, for each said tile in rapid succession, at least one hologram to reproduce an image of the tile, to give the impression of said plurality of the tiles together; and wherein the method further comprises controlling a shutter spatial light modulator (SLM) in a replay field of the holograms such that when each said tile is displayed light for the others of said plurality of tiles is substantially blocked.

Broadly speaking, in embodiments of the method the replay field is divided into blocks or tiles and a controllable shutter is used in the replay field, more particularly at an intermediate image position in the display optics, so that substantially only light for a selected tile is displayed. In other words by dividing the replay field spatially into a number of blocks or tiles the signal can be spatially separated from the background noise in the replay field and then those areas which are known only to contain background noise can be blocked by the shutter. So, for example, for say four blocks or tiles when each is displayed the noise from the other three can be blocked so that the signal-to-noise ratio is effectively increased by a factor of four. The different tiles making up a single image frame may each be of substantially the same size, or may have different sizes. There is also a computational benefit since, overall, it is easier to calculate holograms for multiple smaller images.

In some embodiments of the method multiple holograms may be used for each tile of the displayed image, for example using an OSPR-type procedure to generate multiple temporal subframes for each tile.

Optionally an OSPR procedure with feedback may be employed for improved results. However the technique is not restricted to holograms calculated using an OSPR-type procedure and, in general, any type of procedure may be employed to calculate one or more holograms displaying each spatial tile.

Depending upon the trade-off between computational overhead and noise reduction, in embodiments a procedure for calculating the hologram for displaying a single spatial tile may be employed which moves noise out of the displayed part of the replay field to other parts of the replay field, for example an error diffusion type procedure. In this way, at the expense of increased computation noise can be moved away from the displayed tile to part of the replay field where it is suppressed by the shutter SLM.

In embodiments a calculated hologram covers substantially the entire area of the SLM on which the hologram is displayed (the display SLM) so that substantially all of the light goes into the relevant tile in each case. However the coverage of the tile by the relevant portion of the image differs and thus to compensate for this the holographic image display system is preferably modulated in proportion to the coverage, tile-by-tile. This modulation may take a variety of forms, for example one or more of modulation of the illuminating light intensity, modulation of the illumination time for a particular tile, modulation of the hologram display time, and modulation of the shutter-open time. In embodiments compensation may also be applied from one frame to the next with the aim of overall normalising the brightness for a sequence of frames.

In some preferred embodiments the display, more particularly demagnification optics are configured to form an intermediate image of the replay field and the shutter SLM may conveniently be located at such a position. The shutter SLM may have just a few pixels, for example a number of pixels equal to the number of tiles and having a substantially corresponding spatial extent, or a shutter SLM with a much higher number of pixels may be employed, switching on or off groups of pixels in order to open and close selected to spatial regions of the replay field corresponding to tiles of the displayed image. However in order to reduce the need for exact alignment of a shuttered region of the SLM with that of a tile in the replay field (in the intermediate image) preferably each tile is enlarged slightly so that it extends beyond the edge of a shuttered spatial region of the SLM for a tile. In this way when the relevant tile shutter in the SLM is open the replay field for the tile extends beyond the open region of the shutter, allowing a degree of misalignment. The tolerable degree of misalignment can be traded with the light lost from the replay field from the portion of the replay field extending beyond the open portion of the SLM shutter. In this way misalignment tolerance may be controlled to range from, for example, a few μm to, potentially, hundreds of μm.

In some preferred embodiments the shutter SLM comprises a transmissive ferroelectric liquid crystal SLM. Such devices are commercially available, generally comprising an ITO (Indium Tin Oxide) backplane and pixellated top electrodes sandwiching liquid crystal material. Preferably the gap between pixels of the SLM shutter is less than the image pixel size, preferably much less than this, since otherwise a bright or dark line may appear in the displayed image. In practice this is relatively straightforward to achieve with a pixel gap of the order of 1 or a few μm.

In some preferred embodiments computer program code to implement the above method comprises code to first, optionally, extend the target image to a square frame (for convenience of processing), and to subdivide or decompose the target image into a plurality of blocks or tiles (which may be of arbitrary shape and/or size, depending upon the configuration of the shutter SLM). For each tile one or more holograms is then calculated, for example using an OSPR-type procedure or some other technique and the calculated hologram is output to the display SLM and the shutter SLM is controlled to open a shutter for the corresponding spatial tile in the replay field, more particularly the intermediate image position where the replay field is reproduced and may be spatially filtered. After the one or more holograms corresponding to the selected spatial tile have been displayed the procedure then continues to the next spatial tile and repeats. Each spatial tile is displayed in turn in this way in sequence to cover the displayed image and hence build up a signal image frame; the entire procedure may then be repeated for one or more subsequent image frames (which may comprise frames of a video image).

Thus the invention further provides processor control code to implement the above-described systems and methods, in particular on a data carrier such as a disk, CD- or DVD-ROM, programmed memory such as read-only memory (Firmware), or on a data carrier such as an optical or electrical signal carrier. Code (and/or data) to implement embodiments of the invention may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog (Trade Mark) or VHDL (Very high speed integrated circuit Hardware Description Language). As the skilled person will appreciate such code and/or data may be distributed between a plurality of coupled components in communication with one another.

In a related aspect the invention provides a holographic image display system, the system comprising: a substantially coherent light source; a display SLM to modulate light from said light source with a hologram; display optics to form an image from said hologram, said display optics having an intermediate image position at which an image of a replay field of said hologram is formed; and a shutter SLM at said intermediate image position to spatially filter light forming said displayed image.

Preferably there is also provided a control system configured to drive the display SLM to display the image by displaying each of a plurality of spatial tiles of the image in turn, and to control the shutter SLM to substantially block light from all of the plurality of spatial tiles except for the displayed tile, as each tile is displayed. Preferably, as previously mentioned, the spatial tiles slightly overlap one another.

In some preferred embodiments the shutter SLM comprises a transmissive ferroelectric liquid crystal SLM, and in embodiments, the display SLM may comprise a reflective ferroelectric liquid crystal SLM. The skilled person will understand that the techniques we describe may be employed in either a monochrome or a colour system (as previously mentioned, ibid).

In a still further aspect the invention provides a data processing system, the system comprising: an input to receive image data defining an image to be displayed; a system for dividing said image into a plurality of spatial tiles: a hologram data calculation system to calculate hologram data representing each of said tiles for display on said display SLM; and a shutter control system for controlling said shutter SLM such that light for substantially only a single said tile is displayed at once.

Preferably the system includes a modulation control system to module display of the tiles in proportion to image coverage of the tiles.

In a still further aspect the invention provides a data processing system, the system comprising: an input to receive image data defining an image to be displayed; a system for dividing said image into a plurality of spatial tiles: a hologram data calculation system to calculate hologram data representing each of said tiles for display on said display SLM; and a modulation control system to modulate display of said tiles to compensate for varying coverage by said image of said tiles.

In such a system one would expect little SNR benefit but there could potentially be a computational benefit, in which case embodiments of such a system could help to ensure substantially matching brightness between different parts of an image displayed on different tiles.

Embodiments of the above described methods and systems may be incorporated into a consumer electronics device, or into an advertising or signage system, or into a helmet mounted or head-up display or, for example, an aircraft or automobile.

### BRIEF DESCRIPTION OF THE DRAWINGS

These and other aspects of the invention will now be further described, by way of example only, with reference to the accompanying figures in which:

FIG. 1 shows an example of a consumer electronic device incorporating a holographic projection module;

FIGS. 2a to 2c show, respectively, an example of an optical system for the holographic projection module of FIG. 1, and lens sharing arrangements used with a reflective SLM;

FIG. 3 shows a block diagram of a hologram data calculation system;

FIG. 4 shows the operations performed within the hardware block of FIG. 3;

FIG. 5 shows the energy spectra of a sample image before and after multiplication by a random phase matrix;

FIG. 6 shows an example of a hologram data calculation system with parallel quantisers for the simultaneous generation of two sub-frames from real and imaginary components of complex holographic sub-frame data respectively;

FIG. 7 shows, schematically, a flow diagram of a procedure according to an embodiment of the invention, showing an example of N=4B×6H decomposition with reconstruction;

FIGS. 8a to 8f show, respectively, an image for display, a spatial tiling of the image, and hologram replay fields for the tiling;

FIG. 9 shows a schematic diagram of a holographic image display system incorporating an image-plane shutter according to an embodiment of the invention;

FIG. 10 shows, schematically, use of an image-plane shutter as shown in the system of FIG. 9 for an N=4B×6H segmentation;

FIG. 11 shows more details of an example implementation of an OSPR procedure for the above described block segmentation technique;

FIG. 12 shows a graph of variation of SNR (upper) and signal energy variance (lower) with block count b; and

FIG. 13 shows, schematically, a shutter SLM and an associated spatial tile or block mapping in an embodiment of the invention.

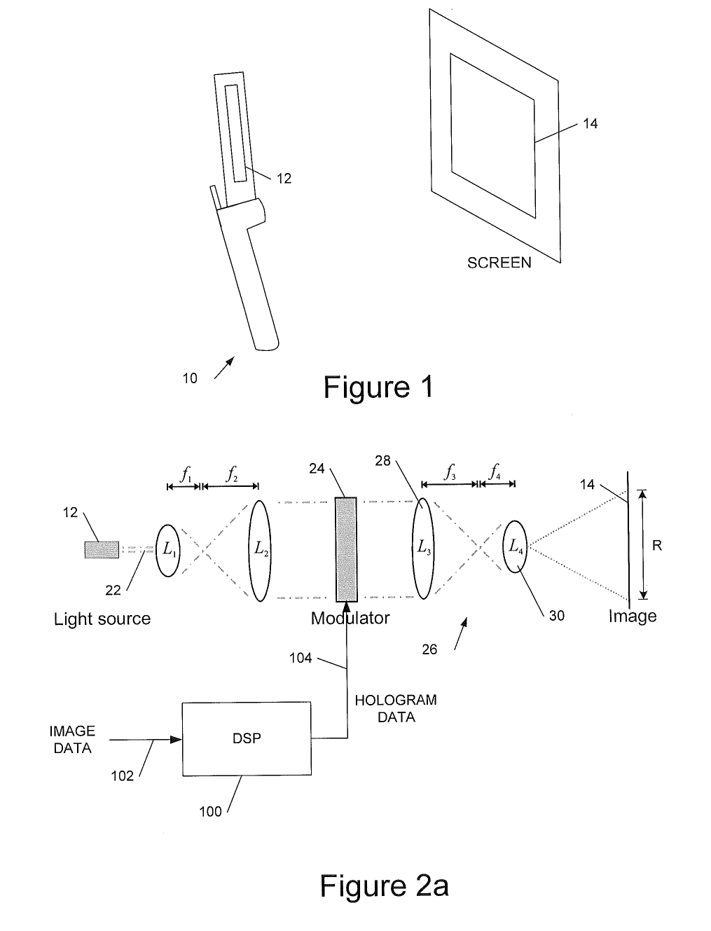

### DETAILED DESCRIPTION OF PREFERRED EMBODIMENTS

It is first helpful, for understanding embodiments of the invention, to review the OSPR procedure. Although we refer to this procedure in a shorthand way as One Step Phase Retrieval (OSPR) strictly speaking in implementations it could be considered that more than one step is employed—as described for example in GB0518912.1 and GB0601481.5, incorporated by reference, where “noise” in one sub-frame is compensated in a subsequent sub-frame—a form of OSPR with feedback. We term this latter technique ADOSPR (Adaptive OSPR).

OSPR

Broadly speaking in our preferred method the SLM is modulated with holographic data approximating a hologram of the image to be displayed. However this holographic data is chosen in a special way, the displayed image being made up of a plurality of temporal sub-frames, each generated by modulating the SLM with a respective sub-frame hologram. These sub-frames are displayed successively and sufficiently fast that in the eye of a (human) observer the sub-frames (each of which have the spatial extent of the displayed image) are integrated together to create the desired image for display.

Each of the sub-frame holograms may itself be relatively noisy, for example as a result of quantising the holographic data into two (binary) or more phases, but temporal averaging amongst the sub-frames reduces the perceived level of noise. Embodiments of such a system can provide visually high quality displays even though each sub-frame, were it to be viewed separately, would appear relatively noisy.

The procedure is a method of generating, for each still or video frame I=I_{xy}, sets of N binary-phase holograms h⁽¹⁾ . . . h^{(N)}. In embodiments such sets of holograms form replay fields that exhibit mutually independent additive noise. An example is shown below:

$$1. Let {G}_{xy}^{( n )} = {I}_{xy} exp ( j {ϕ}_{xy}^{( n )} ) where {ϕ}_{xy}^{( n )} is uniformly distributed$$

$$between 0 and 2 π for 1 \leq n \leq N / 2 and 1 \leq x , y \leq m$$

$$2. Let {g}_{uv}^{( n )} = {F}^{- 1} [ {G}_{xy}^{( n )} ] where {F}^{- 1} represents the$$

$$two \text{-} dimensional inverse Fourier transform operator , \\ for 1 \leq n \leq N / 2$$

$$3. Let {m}_{uv}^{( n )} = \{ {g}_{uv}^{( n )} \} for 1 \leq n \leq N / 2$$

$$4. Let {m}_{uv}^{( n + N / 2 )} = \{ {g}_{uv}^{( n )} \} for 1 \leq n \leq N / 2 \\ 5. Let {h}_{uv}^{( n )} = \{ \begin{matrix}- 1 & if {m}_{uv}^{( n )} < {Q}^{( n )} \\ 1 & if {m}_{uv}^{( n )} \geq {Q}^{( n )}\end{matrix} \\ where {Q}^{( n )} = median ( {m}_{uv}^{( n )} ) \\ and 1 \leq n \leq N$$

Step 1 forms N targets G_{xy}⁽ⁿ⁾ equal to the amplitude of the supplied intensity target I_{xy}, but with independent identically-distributed (i.i.t.), uniformly-random phase. Step 2 computes the N corresponding full complex Fourier transform holograms gᵤᵥ⁽ⁿ⁾. Steps 3 and 4 compute the real part and imaginary part of the holograms, respectively. Binarisation of each of the real and imaginary parts of the holograms is then performed in step 5: thresholding around the median of mᵤᵥ⁽ⁿ⁾ ensures equal numbers of −1 and 1 points are present in the holograms, achieving DC balance (by definition) and also minimal reconstruction error. The median value of mᵤᵥ⁽ⁿ⁾ may be assumed to be zero with minimal effect on perceived image quality.

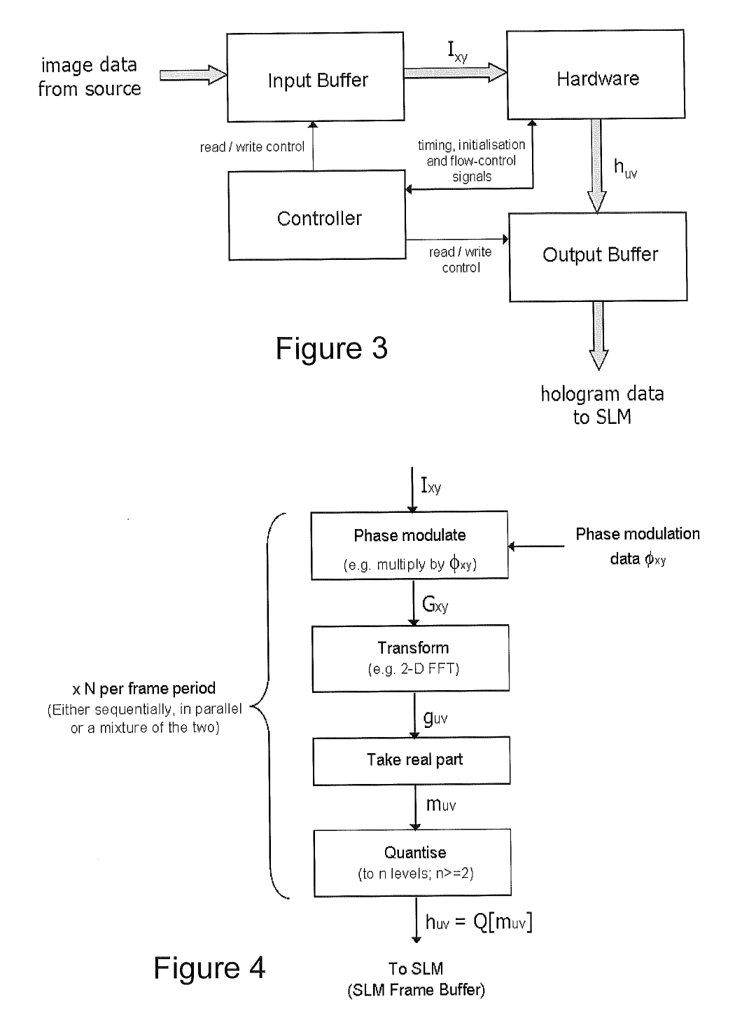

FIG. 3 (from GB0511962.3, filed 14^{th} Jun. 2005, incorporated by reference) shows a block diagram of a hologram data calculation system configured to implement this procedure. The input to the system is preferably image data from a source such as a computer, although other sources are equally applicable. The input data is temporarily stored in one or more input buffer, with control signals for this process being supplied from one or more controller units within the system. The input (and output) buffers preferably comprise dual-port memory such that data may be written into the buffer and read out from the buffer simultaneously. The control signals comprise timing, initialisation and flow-control information and preferably ensure that one or more holographic sub-frames are produced and sent to the SLM per video frame period.

The output from the input comprises an image frame, labelled I, and this becomes the input to a hardware block (although in other embodiments some or all of the processing may be performed in software). The hardware block performs a series of operations on each of the aforementioned image frames, I, and for each one produces one or more holographic sub-frames, h, which are sent to one or more output buffer. The sub-frames are supplied from the output buffer to a display device, such as a SLM, optionally via a driver chip.

FIG. 4 shows details of the hardware block of FIG. 3; this comprises a set of elements designed to generate one or more holographic sub-frames for each image frame that is supplied to the block. Preferably one image frame, I_{xy}, is supplied one or more times per video frame period as an input. Each image frame, I_{xy}, is then used to produce one or more holographic sub-frames by means of a set of operations comprising one or more of: a phase modulation stage, a space-frequency transformation stage and a quantisation stage. In embodiments, a set of N sub-frames, where N is greater than or equal to one, is generated per frame period by means of using either one sequential set of the aforementioned operations, or a several sets of such operations acting in parallel on different sub-frames, or a mixture of these two approaches.

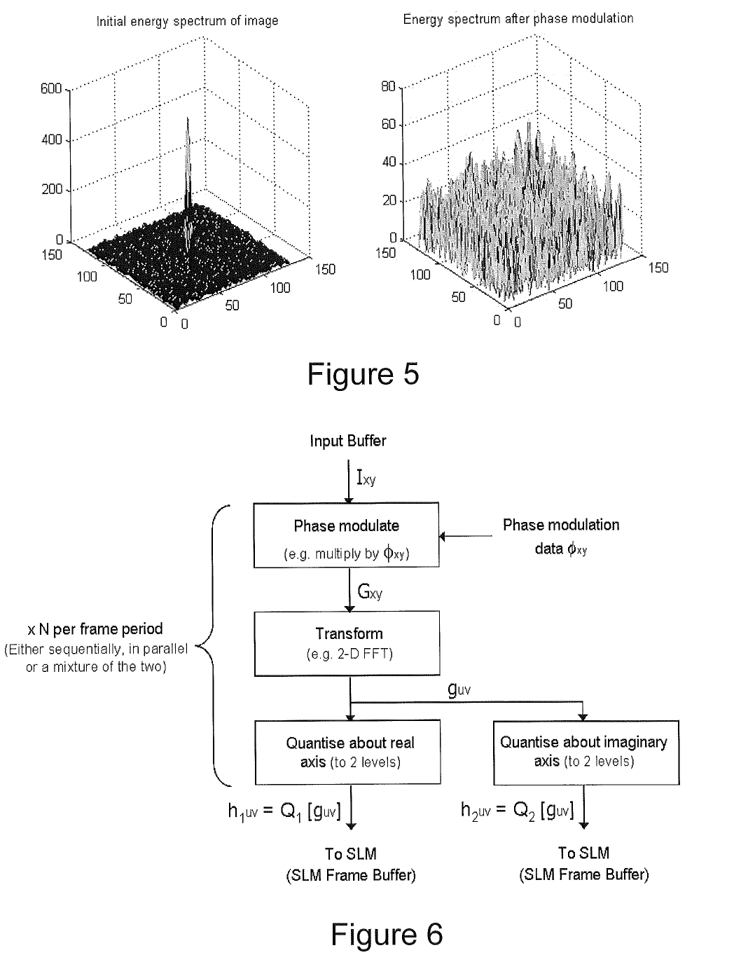

The purpose of the phase-modulation block is to redistribute the energy of the input frame in the spatial-frequency domain, such that improvements in final image quality are obtained after performing later operations. FIG. 5 shows an example of how the energy of a sample image is distributed before and after a phase-modulation stage in which a pseudo-random phase distribution is used. It can be seen that modulating an image by such a phase distribution has the effect of redistributing the energy more evenly throughout the spatial-frequency domain. The skilled person will appreciate that there are many ways in which pseudo-random binary-phase modulation data may be generated (for example, a shift register with feedback).

The quantisation block takes complex hologram data, which is produced as the output of the preceding space-frequency transform block, and maps it to a restricted set of values, which correspond to actual modulation levels that can be achieved on a target SLM (the different quantised phase retardation levels may need not have a regular distribution). The number of quantisation levels may be set at two, for example for an SLM producing phase retardations of 0 or π at each pixel.

In some preferred embodiments the quantiser is configured to separately quantise real and imaginary components of the holographic sub-frame data to generate a pair of holographic sub-frames, each with two (or more) phase-retardation levels, for the output buffer. FIG. 6 shows an example of such a system. It can be shown that for discretely pixellated fields, the real and imaginary components of the complex holographic sub-frame data are uncorrelated, which is why it is valid to treat the real and imaginary components independently and produce two uncorrelated holographic sub-frames.

ADOSPR

In the OSPR approach we have described above subframe holograms are generated independently and thus exhibit independent noise. In control terms, this is an open-loop system. However one might expect that better results could be obtained if, instead, the generation process for each subframe took into account the noise generated by the previous subframes in order to cancel it out, effectively “feeding back” the perceived image formed after, say, n OSPR frames to stage n+1 of the algorithm. In control terms, this is a closed-loop system.

One example of this approach comprises an adaptive OSPR algorithm which uses feedback as follows: each stage n of the algorithm calculates the noise resulting from the previously-generated holograms H₁ to Hₙ₋₁, and factors this noise into the generation of the hologram Hₙ to cancel it out. As a result, it can be shown that noise variance falls as 1/N². An example procedure takes as input a target image T, and a parameter N specifying the desired number of hologram subframes to produce, and outputs a set of N holograms H₁ to H_{N} which, when displayed sequentially at an appropriate rate, form as a far-field image a visual representation of T which is perceived as high quality. In more detail, an example procedure is as follows:
A preprocessing step generates a modified target image T′ from the supplied target T according to the relation T′(x, y)=T(x, y)^{1.3}. This is employed to match the energy properties of a standardized (CRT) display, so that an image projected holographically will appear the same in terms of gamma as if the image were shown on a conventional display.
At each stage n of the algorithm (out of a total of N stages), the array F keeps track of the “running total” (consisting of the desired image, plus noise) of the image energy formed by the previous holograms H₁ to Hₙ₋₁ so that the noise may be evaluated and taken into account in the subsequent stage. F is initialized to zeroes at the start of the procedure, and at each stage n the image energy from the hologram Hₙ₋₁ formed in the previous stage is calculated using a Fourier transform and added, i.e.

F(x, y):=F(x, y)+ [symbol] [Hₙ₋₁(x,y)]|²
A random phase factor φ is added at each stage to each pixel of the target image. The addition of this randomized phase component results in even distribution of the energy in the frequency domain, which is preferred to avoid excessive quality degradation in the subsequent quantization step.
At each stage, the target image is adjusted to take the noise from the previous stages into account. The adjustment is carried out by calculating a scaling factor α to match the intensity of the noisy “running total” energy F with the target image energy (T′)², such that the total noise energy from the previous n−1 stages is given by αF−(n−1)(T′)², according to the relation

$$α := \frac{{\sum }_{x , y} {{T}^{′} ( x , y )}^{4}}{{\sum }_{x , y} F ( x , y ) \cdot {{T}^{′} ( x , y )}^{2}}$$

Therefore, the target energy required at this stage is given by the difference between the desired target energy at this iteration and the previous noise present in order to cancel that noise out, i.e. (T′)²−[αF−(n−1)(T′)²]=n(T′)²+αF, giving a required target amplitude |T″| equal to the square root of this energy value, i.e.

$${T}^{″} ( x , y ) := \{ \begin{matrix}\sqrt{2 {{T}^{′} ( x , y )}^{2} - α F} \cdot exp \{ j φ ( x , y ) \} & if 2 {{T}^{′} ( x , y )}^{2} > α F \\ 0 & otherwise\end{matrix}$$

At each stage n, H represents an intermediate fully-complex hologram formed from the target T″ and is calculated using an inverse Fourier transform operation. It is quantized to binary phase to form the output hologram Hₙ, i.e.

$$H ( x , y ) := {- 1}^{} [ {T}^{″} ( x , y ) ]$$

$${H}_{n} ( x , y ) = \{ \begin{matrix}1 & if Re [ H ( x , y ) ] > 0 \\ - 1 & otherwise\end{matrix}$$

Contrast Improvement Using an Image-Plane Shutter

We have described above how OSPR and related techniques are useful for reducing noise variants. However noise is not the only measure that needs to optimise against in order to achieve high-quality image reproduction. Another important parameter is the contrast ratio, defined as the mean energy in the signal region divided by the mean energy in the background region. For a projection system operating in a high-ambient-light environment such as the office or in daylight, contrast ratio can never be very high (for a typical business projector, often just 2:1 or 3:1) unless the image is very bright as the mean energy in the background region can never fall below the ambient illumination level. However, in typically darker environments such as a cinema auditorium, poor contrast can manifest itself very observably as a washed-out image.

For a holographic imaging system one can define a parameter p which is a measure of the total noise energy or background noise level independent of the image displayed. For OSPR p=0.6321, implying that about 30% of the light energy goes into noise as compared with the image. One can further define a parameter c which defines the coverage of an image, that is the energy in the desired image as a proportion of the maximum available energy. The average contrast ratio in a holographically replayed image is given by the expression

$$1 + \frac{p}{c ( 1 - p )} ,$$

which for OSPR (p=0.6321) results in the theoretical contrast ratios given below in Table 1, for various different test images.

TABLE 1
Test images and associated coverages,
and contrast ratios obtained with OSPR.

| Test image | Coverage c | Contrast ratio R:1 |
|---|---|---|
| Two-level test (AJC text) | 0.0672 | 26.6 |
| Low-coverage video frame | 0.0758 | 23.7 |
| (gingerbread man) | | |
| Quarter-white block | 0.1582 | 11.9 |
| Medium-coverage video | 0.2058 | 9.3 |
| frame (20^{th} Century Fox) | | |
| High-coverage video frame | 0.3187 | 6.4 |
| (car at gates) | | |
| All-white video image | 0.6328 | 3.7 |

We now describe some techniques to improve these contrast ratios.

Block Segmentation in Holographic Replay

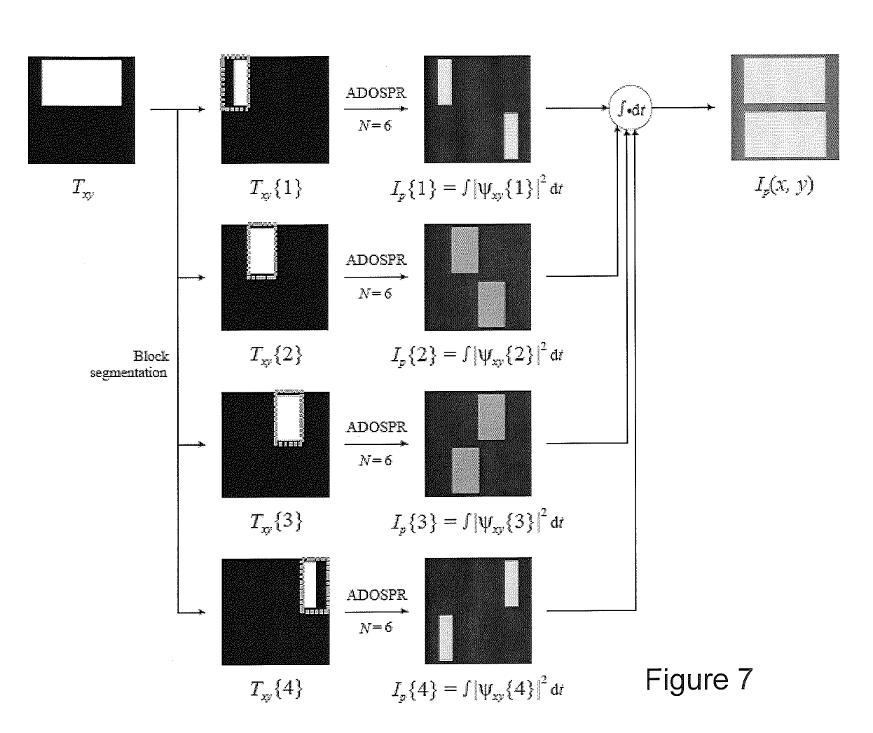

In the previously-described OSPR and OSPR-with-feedback approaches, every hologram subframe reproduces the same target image, but with different additive reconstruction noise. One alternative approach is to subdivide the image spatially into blocks, so that subsets of subframes produce a block-by-block reconstruction of the image. For example, if we consider an all-white video image test target with N=24 holograms per video frame, we can subdivide the target into (for example) four blocks, with subframes 1 to 6 reconstructing the first block (which we will call {1} _{xy} T), 7 to 12 reconstructing the second block {2} _{xy} T, 13 to 18 reconstructing the third block {3 } _{xy} T and 19 to 24 reconstructing the fourth block {1 } _{x,y} T, as shown in FIG. 7. We will term this decomposition N=4B×6H, representing 4 blocks per frame, and 6 holograms per block, with the eye perceiving the intensity summation of all 4×6=24 subframes.

Note that because the different block targets T_{xy} {b} have different coverages, they will form reproductions with different relative brightness (which we have shown previously are proportional to

$$\frac{p}{c \{ b \}} ) ,$$

as can be seen from the above figure (blocks 1 and 4 produce brighter reconstructions as they have lower coverages), where we define c{b} as the coverage of block number b as follows:

$$c \{ b \} = \{ \begin{matrix}\frac{\sum {( {T}_{xy} \{ b \} )}^{2}}{{M}^{2}} & phase levels > 2 \\ 2 \frac{\sum {( {T}_{xy} \{ b \} )}^{2}}{{M}^{2}} & \begin{matrix}binary phase ( due \\ to conjugate image )\end{matrix}\end{matrix}$$

In order to compensate for this to ensure the reproduction has uniform brightness across the blocks, as shown in FIG. 7, we can employ one of several methods, which all give equivalent results:
Display each subframe of block number b for a time proportional to

$$\frac{c \{ b \}}{p}$$

Display each subframe of block b for the same length of time t, but illuminate the subframe for a time t′≦t proportional to

$$\frac{c \{ b \}}{p}$$

Display each subframe of block number b for the same length of time t, but modulate the illumination power proportional to

$$\frac{c \{ b \}}{p}$$

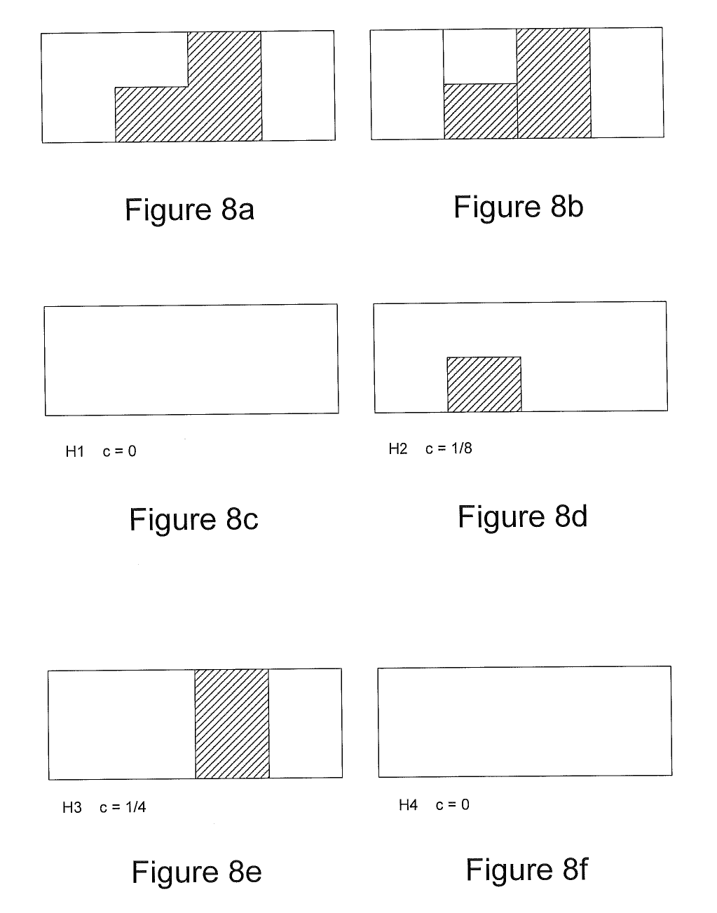

FIG. 8 shows another example in which FIG. 8a shows an image to be displayed, FIG. 8b a spatial tiling with equal sized blocks, and FIGS. 8c to 8f the replay fields of four holograms H₁ to H₄ for displaying each of the tiles of FIG. 8b. Assuming the image is at 100% intensity the coverage, c of H₁ is c=0, for H₄ c=0, for H₂ c=⅛ and for H3 c=¼ (more precisely, where a conjugate image is present, these numbers should be halved).

We now describe the noise properties of using the block-segmentation approach. We find that using (for example) an N=4B×6H decomposition as described above with ADOSPR results in substantially worse noise performance than standard ADOSPR with N=24. This is to be expected, as unlike in standard ADOSPR where signal noise in any given subframe is subsequently actively compensated for in all subsequent subframes, in the block-segmentation approach, one finds that noise in one block cannot be adaptively compensated for in the next block. The reason for this is that the area occupied by the image segment in one block is necessarily zero in all other blocks, and as a result the adaptive noise compensation fails between blocks. Additionally, we find that using an N=4B×6H decomposition with standard OSPR results in worse noise performance than standard OSPR with N=24. These results are summarized in Table 2.

TABLE 2
Comparison of OSPR-type procedures with
and without block decomposition.

| | | Block | | Block |
|---|---|---|---|---|
| | ADOSPR | ADOSPR | OSPR | OSPR |
| Statistic | (N = 24) | (N = 4B × 6H) | (N = 24) | (N = 4B × 6H) |
| Signal energy | 1.372 | 1.391 | 1.372 | 1.391 |
| mean μ_{S} | | | | |
| Signal energy | 0.0019 | 0.0128 | 0.0361 | 0.0544 |
| variance σ_{S}² | | | | |
| Background | 0.358 | 0.326 | 0.358 | 0.326 |
| energy mean μ_{ε} | | | | |
| Background | 0.00540 | 0.00708 | 0.00535 | 0.00710 |
| energy variance | | | | |
| σ_{ε}² | | | | |
| SNR (contrast | 3.83 | 4.27 | 3.83 | 4.27 |
| ratio) s | | | | |
| Uniformity U | 990.7 | 151.2 | 52.1 | 35.6 |
| Sample image | [symbol] | [symbol] | [symbol] | [symbol] |
| section | | | | |

While we find that using the block segmentation approach does increase SNR slightly (by 11%), signal energy variance, which as we have described has a very strong correlation with perceived noise level, increases (for ADOSPR) by 670% when using block decomposition compared with standard ADOSPR, which results in lower perceived image quality when using block segmentation in this way.

Image-Plane Shutter Technique

We analysed the above block segmentation technique and concluded that it is not particularly useful as using it increases noise variance, which correlates directly with the perceived level of noise. The reason for this increase is that, as previously described, noise does not cancel between blocks, and so the efficacy of the multiple holograms per video frame technique is reduced.

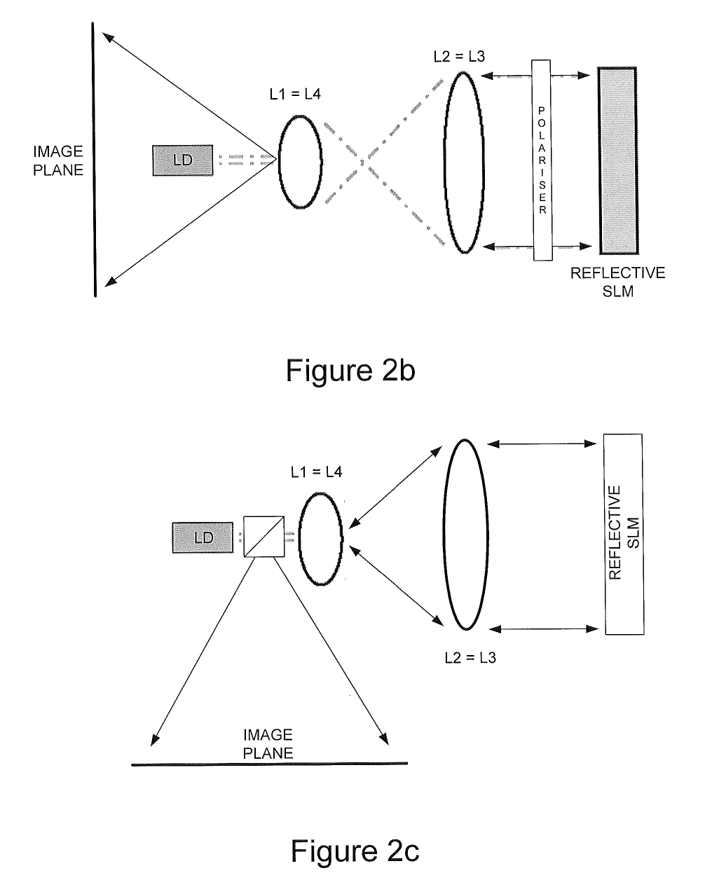

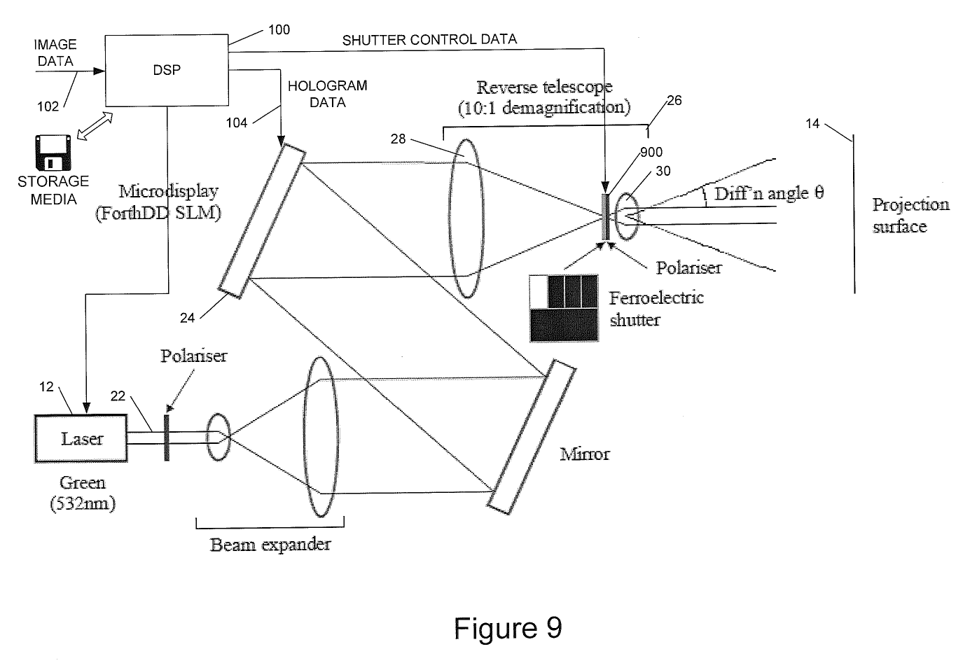

We address this problem by introducing an image-plane shutter. As described above, a preferred optical architecture features an intermediate image plane in between the demagnification lens pair in the output stage. In this plane, a reconstruction or replay image is formed of height

$$\frac{{f}_{1} λ}{Δ} ,$$

where f₁ is the focal length of the first lens in the demagnification pair and Δ is the pixel size. Referring to FIG. 9, in which like elements to those of FIG. 2a are indicated by like reference numerals, we introduce in this plane a shutter 900, preferably with a small number of pixels, each covering the area occupied by one block in the desired segmentation, which can take, for example, the form of a small direct-drive transmissive ferroelectric cell in amplitude modulation mode (i.e. with a single polariser after the cell). The physical size of the shutter is preferably equal to that of the first order of the intermediate image

$$\frac{{f}_{1} λ}{Δ} ,$$

which for a microdisplay (available, for example, from Forth D. D, ibid) illuminated with green light and a demagnification lens of f₁=250 mm corresponds to a shutter size of 9.8 mm×9.8 mm. In general the shutter has a size of from one or a few millimetres to about a centimetre.

A DSP 100 performs the hologram calculation procedure, for example an OSPR-type procedure for each spatial tile, and in addition controls the ferroelectric shutter 900 in synchronism with the display of the tiles. Preferably the DSP also modulates the system in proportion to the coverage, as described above, for example by modulating the laser power. The processor control code to perform these operations may be stored on a carrier medium, as illustrated.

The shutter is preferably controlled in synchronisation with the microdisplay so that when a hologram corresponding to a subframe of block number b is displayed, every pixel of the ferroelectric cell is set to the black state except for the pixel directly over block b's area, set to the transmissive state, as illustrated in FIG. 9. As a result, all noise not in block b's signal area is blocked by the ferroelectric cell, so it does not contribute to the overall noise level in the reproduction. In embodiments the laser power when displaying each block b is modulated (or the block display time varied) in inverse proportion to the block coverage c{b} to maintain a substantially constant brightness level between blocks.

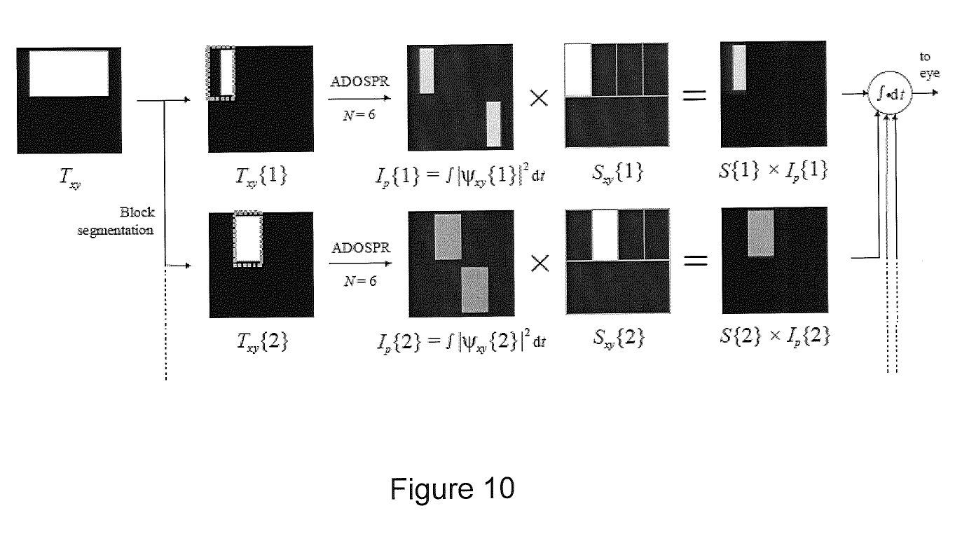

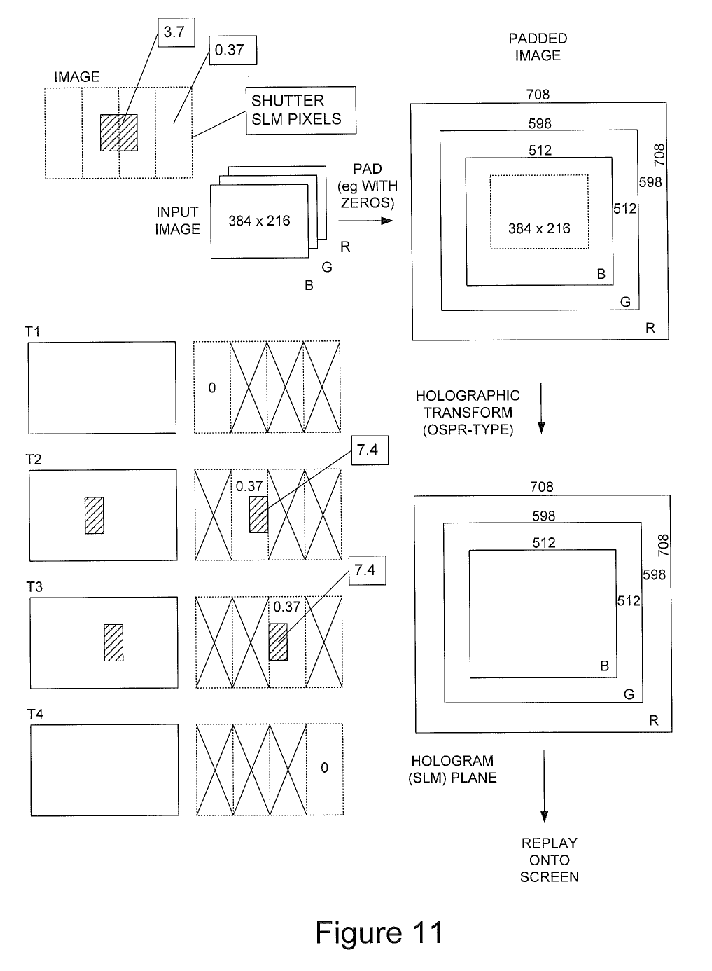

FIG. 10 shows, schematically, use of an image-plane shutter as shown in the system of FIG. 9 for an N=4B×6H segmentation. FIG. 11 shows more details of an example implementation of an OSPR procedure for the above described block segmentation technique. The example shows a rectangular input image being padded so that it occupies a square frame. The example also shows how different degrees of padding may be employed for different colours in a colour holographic image display system, to compensate for differing diffraction of the differing colours, in an image display system in which the colours are time multiplexed and share a common spatial light modulator (further details can be found in our UK patent application GB0610784.1 filed 2^{nd} Jun. 2006).

The image is then subdivided into, in the illustrated example, four spatial tiles or blocks, each of which undergoes a holographic, for example OSPR-type, transform to provide a hologram which is replayed into a screen. The figure also illustrates four target images T₁ to T₄, and example SNR values.

The image in the example at FIG. 11 has a signal level of 3.7 and a background noise level of 0.37 giving an SNR of approximately 10. However for targets T₂ and T₄ the signal has double the intensity, that is 7.4. The averaging over four targets reduces this but there is still an overall gain in SNR. More particularly signal S=(0+7.4+0)÷4=14.8÷4, and noise N=(0+0.37+0.37+0)÷4=0.74÷4 and therefore the SNR=14.8÷0.74=20. Thus it can be seen there is an effective doubling of the signal to noise ratio. (The foregoing presumes that the FLC shutter is turned off entirely for targets T₁ and T₄, otherwise the background level of 0.37 is still present and the increase in SNR is smaller, though still very significant.)

Results (assuming negligible shutter transmission in the dark state) are shown in Table 3. As can be seen, using four-block (AD)OSPR with the image-plane shutter gives substantially lower (AD)OSPR without the shutter, leading to an almost four-fold improvement in contrast ratio compared with standard (AD)OSPR, although—as for the case without the shutter—the signal energy variance is still higher than that of standard (AD)OSPR, giving rise to reduced image uniformity caused by a greater amount of noise in the signal region.

TABLE 3
Comparison of block OSPR with and without shutter

| | | Block ADOSPR w/o | Block ADOSPR with |
|---|---|---|---|
| | ADOSPR | shutter | shutter |
| Statistic | (N = 24) | (N = 4B × 6H) | (N = 4B × 6H) |
| Signal energy | 1.372 | 1.391 | 1.391 |
| mean μ_{S} | | | |
| Signal energy | 0.0019 | 0.0128 | 0.0128 |
| variance σ_{S}² | | | |
| Background | 0.358 | 0.326 | 0.093 |
| energy mean μ_{ε} | | | |
| Background | 0.00540 | 0.00708 | 0.00357 |
| energy variance | | | |
| σ_{ε}² | | | |
| SNR (contrast | 3.83 | 4.27 | 14.95 |
| ratio) s | | | |
| Uniformity u | 990.7 | 151.2 | 151.2 |
| Sample image | [symbol] | [symbol] | [symbol] |
| section | | | |

We now consider how the number of blocks employed affects the noise and SNR figures. For example, if we wish to employ N=24 holograms per video frame, we have a choice of a number of different segmentations: N=1B×24H (standard ADOSPR), 2B×12H, 3B×8H, 4B×6H (as described above), 6B×4H, 12B×2H, and 24B×1H (no noise averaging within each block). Results for each these segmentations are given in Table 4.

TABLE 4
Variation of reconstruction statistics with different N = 24 block segmentation

| Statistic | 1B × 24H | 2B × 12H | 3B × 8H | 4B × 6H | 6B × 4H | 12B × 2H | 24B × 1H |
|---|---|---|---|---|---|---|---|
| Signal energy mean μₛ | 1.372 | 1.392 | 1.382 | 1.391 | 1.389 | 1.386 | 1.392 |
| Signal energy variance σₛ² | 0.0019 | 0.0046 | 0.0116 | 0.0128 | 0.0289 | 0.0879 | 0.3270 |
| Background energy mean μ_{ε} | 0.358 | 0.214 | 0.136 | 0.093 | 0.058 | 0.043 | 0.032 |
| Background energy variance σ_{ε}² | 0.00540 | 0.00383 | 0.00619 | 0.00357 | 0.00507 | 0.00449 | 0.00528 |
| SNR (contrast ratio) s | 3.83 | 6.50 | 10.16 | 14.95 | 23.95 | 32.23 | 43.50 |
| Uniformity u | 990.7 | 421.2 | 164.6 | 151.2 | 66.8 | 21.9 | 5.9 |

As can be seen, increasing the number of blocks in the segmentation results in a decrease in background energy mean and hence a marked increase in SNR, at the expense of an increase in signal energy variance and therefore an increase in perceived noise in the signal region of the image. If the number of blocks in the segmentation is doubled, the expected coverage c{b} of each block will roughly halve, and hence from the standard noise model the SNR can be expected to double. There is effectively no change in signal energy mean or background energy variance.

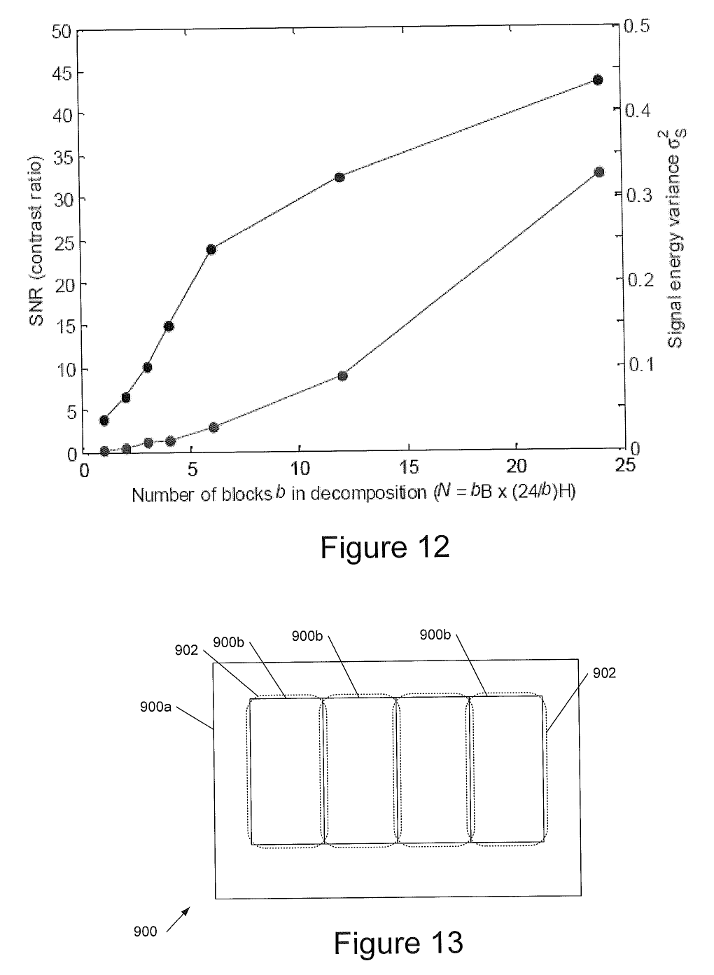

FIG. 12 shows a graph of variation of SNR (upper) and signal energy variance (lower) with block count b. From the graph in FIG. 12, the above deduction is indeed what is observed when the number of blocks in the segmentation is small. For segmentations into larger numbers of blocks, the expected proportional gain in SNR is not realised. This is because for segmentations into lots of blocks, c{b} for a given block b will tend to be low, and as previously described, targets of very low coverage will exhibit greater than expected noise because with few “on” pixels in the target, there are fewer degrees of freedom available in the target image pixel phases with which to optimise the hologram, and such a restriction in degrees of freedom manifests itself as additional noise.

Thus, referring again to FIG. 12, it can be seen that as the number of blocks in the decomposition is increased from 1 there is initially a substantial gain in SNR for very little increase in signal energy variants although as the number of blocks increases above around 6 the SNR gain reduces whilst the signal energy variants increases faster. Thus the graph of FIG. 12 can be used to determine the trade off between these two parameters according to a desired application.

As previously mentioned, broadly speaking the signal window corresponds to the block or spatial tile to be represented. However FIG. 13 shows a preferred mapping whilst allows for some degree of mis-alignment. More particularly, FIG. 13 shows, schematically, a shutter SLM 900 comprising a back electrode 900A and pixel electrodes 900B, four in the illustrated example, together with an example spatial tile mapping, shown by dashed lines 902. It can be seen that providing this tile mapping overlaps the pixel electrodes in the replay field a small amount of mis-alignment of the shutter SLM 900 can be tolerated.

Error Diffusion

In some implementations it may be desirable to reduce the noise in a spatial block or tile still further. Error diffusion allows noise to be shifted outside a spatial window or region of interest which will, in general, correspond to a spatial tile or block as described above. Whether it is desirable to implement such a technique depends upon a trade-off between processing power employed and desired image SNR.

We describe below an example error diffusion technique which may be employed if desired. We also have previously described, in GB0622777.1 filed 15 Nov. 2006, hereby incorporated by reference in its entirety, a hardware error diffusion calculation system, designed to act as a co-processor to augment an OSPR computation engine. Optionally if an error diffusion-type technique is employed such a hardware accelerator may also advantageously be used.

Error diffusion techniques applied to the binarisation of continuous hologram patterns have been described in the following background material: M. P. Chang and O. K. Ersoy, “Iterative interlacing error diffusion for synthesis of computer-generated holograms,” Applied Optics, vol. 32, pp. 3122-, 1993; R. Eschbach, “Comparison of error diffusion methods for computer-generated holograms,” Applied Optics, vol. 30, pp. 4361-, 1991; R. Eschbach and Z. Fan, “Complex-valued error diffusion for off-axis computer generated holograms,” Applied Optics, vol. 32, pp. 3130-1993; A. A. Falou, M. Elbouz, and H. Hamam, “Segmented phase-only filter binarised with a new error diffusion approach,” Journal of Optics A: Pure and Applied Optics, vol. 7, 2005; O. B. Frank Fetthauer, “On the error diffusion algorithm: object dependence of the quantization noise,” Optics Communications, vol. 120, 1995; F. Fetthauer and O. Bryngdahl, “Use of error diffusion with space-variant optimized weights to obtain high-quality quantized images and holograms,” Optics Letters, vol. 23, pp. 739-741, 1998; L. Ge, M. Duelli, and R. W. Cohn, “Improved-fidelity error diffusion through blending with pseudorandom encoding,” J. Opt. Soc. Am. A, vol. 17, pp. 1606-1616, 2000.

An error diffusion procedure with two variants, ED and MAE, is given below. The example procedure relates to a P×P pixel hologram (although there is no need for u and v both to have ranges [1;P]) with pixel dimensions [u,v] within which a window with pixel dimensions [r,s] is defined.

$$\begin{matrix}1. Let {e}_{uv} = 0 & ∀ u , v ∈ [ 1 ; P ] \\ 2. Let {m}_{uv}^{c} = {m}_{uv} + {\sum }_{r , s} {d}_{rs} {e}_{u - r , v - s} & \begin{matrix}u , v ∈ [ 1 ; P ] \\ r , s ∈ [ 1 ; K ]\end{matrix} \\ 3. Let {e}_{uv} = \{ \begin{matrix}{m}_{uv} - {h}_{uv} \\ {m}_{uv}^{c} - {h}_{uv}\end{matrix} & \begin{matrix}MAE algorithm \\ ED algorithm\end{matrix} \\ 4. Let {h}_{uv} = \{ \begin{matrix}- 1 & if {m}_{uv}^{c} < Q \\ 1 & if {m}_{uv}^{c} \geq Q\end{matrix} & where Q = median ( {m}_{uv}^{c} )\end{matrix}$$

In this procedure mᵤᵥ represents continuous hologram data (real and/or imaginary component), eᵤᵥ diffused errors, dᵣₛ diffusion weights, and hᵤᵥ a binary phase representation of the hologram. In the techniques we describe later mᵤᵥ may comprise a real or imaginary component of hologram data from an OSPR procedure. Conveniently Q is a median pixel value but may also be a constant, for example zero.

To obtain local SNR improvement in a window W defined in the RPF (replay field) RPF noise is optimised in the region W by diffusing hologram pixels according to a diffusion kernel of size K where dᵣₛ is the appropriately bandlimited Fourier transform of the window function W. More particularly the diffusion kernel is calculated by calculating the Fourier transform (in 2 or more dimensions) of the window function, and then truncating the potentially infinite Fourier series, for example taking a set of components around zero-spatial frequency. The window function may conveniently comprise a function defined over the area of the replay field, with a value of “1” over the window and a value of “0” elsewhere.

In step 2 eᵤᵥ comprises a matrix which represents errors introduced by the quantisation (binarisation) process, more particularly the error in binarising one or more previous pixels [u,v]. The diffusion kernel dᵣₛ represents a weighting of these errors over a window of dimension [r,s], preferably centred on the currently processed pixel [u,v].

As shown, the error matrix eᵤᵥ may initially be set to zero and will gradually accumulate error data as more pixels are processed. An error for a currently processed pixel is calculated at step 3. There are two main ways in which this error may be determined, although applications of embodiments of the invention are not limited to these. A Minimum Average Error (MAE) calculation may be employed to determine the difference between a binarised pixel value hᵤᵥ and a real (and/or imaginary) part of the complex hologram data; or in a standard error diffusion (ED) procedure the difference may be between the binarised pixel value and a changed (c) value determined in error diffusion step 2. These two approaches merely differ in the quantisation of the diffused errors eᵤᵥ and can be made to behave equivalently by appropriate choice of the diffusion weights dᵣₛ. Thus either an ED or an MAE procedure can be implemented by changing the kernel (i.e. the data stored in the diffusion kernel memory) and embodiments of the invention we describe are able to implement both ED and MAE (but not limited to these).

An example of an error diffusion technique with iterative weight calculation is described in: A. Kirk, K. Powell, and T. Hall, “A generalisation of the error diffusion method for binary computer generated hologram design,” Optics Communications, vol. 92, 1992.

The binarisation step 4 of the procedure may then performed: thresholding around the median provides substantially equal numbers of −1 and 1 points in the hologram, giving DC balance and also low reconstruction error. However the median value may be assumed to be zero with minimal impact on perceived image quality.

Broadly speaking the error diffusion step 2 diffuses errors over a window of size [r,s] determining a changed or adjusted value for the real and/or imaginary component of the complex hologram data taking into account these diffused errors, that is taking into account the binarisation which is employed (at a later step) for displaying the hologram on an. The error broadly speaking comprises a difference between a quantised (binarised) pixel and the unquantised, continuous value of the pixel.

The region over which the error diffusion is applied depends upon the size of the window, a larger window using a larger diffusion kernel. Broadly speaking the size of the diffusion kernel determines the “quality” of the diffusion process but a larger kernel, even with hardware, requires greater computation. Similarly a greater improvement in signal-to-noise ratio (SNR) can be achieved by using a larger diffusion kernel (or a less truncated Fourier series): The window becomes increasingly well-defined, the SNR increases and the signal and noise histograms become increasingly better separated.

Thus there is a trade off between the window size, desired SNR improvement, and the number of hardware error diffusion processors (as described below). In theory the size of the window can approach the size of the replay field but it then becomes harder to remove noise from the window; in practice a smaller window can nonetheless provide useful benefits because the points in the (replay field) window are still effectively at higher resolution, albeit the image area is reduced. The RPF noise energy falls rapidly as K increases, leading to a similarly rapid SNR rise. In one implementation of the above described hardware system increased computation outweighed the benefit of increased SNR at approximately K=15, which was set as the maximum kernel size.

If used with embodiments of the spatial tiling technique described above a window may correspond to the size of a spatial tile or block. Broadly smaller windows are helpful as they provide a greater area outside the window to which noise may be shifted, thus facilitating the error diffusion calculation.

Conclusion

The techniques we have described are particularly useful for applications where SNR is the most important parameter. For video applications a relatively small number of blocks, for example 2, 3 or 4 blocks is preferred to limit the increase in the noise level in the signal region of the image. Nonetheless, applications for the described techniques and modulators include, but are not limited to the following: mobile phone; PDA; laptop; digital camera; digital video camera; games console; in-car cinema; navigation systems (in-car or personal e.g. wristwatch GPS); head-up and helmet-mounted displays for automobiles and aviation; watch; personal media player (e.g. MP3 player, personal video player); dashboard mounted display; laser light show box; personal video projector (a “video iPod (RTM)” concept); advertising and signage systems; computer (including desktop); remote control unit; an architectural fixture incorporating a holographic image display system; more generally any device where it is desirable to share pictures and/or for more than one person at once to view an image.

No doubt many effective alternatives will occur to the skilled person and it will be understood that the invention is not limited to the described embodiments and encompasses modifications apparent to those skilled in the art lying within the spirit and scope of the claims appended hereto.

1. A method of displaying an image holographically, the method comprising:
dividing said image into a plurality of spatial tiles; and
displaying, for each said tile in rapid succession, at least one hologram to reproduce an image of the tile, to give the impression of said plurality of the tiles together; and
wherein the method further comprises controlling a shutter spatial light modulator (SLM) in a replay field of the holograms such that when each said tile is displayed light for the others of said plurality of tiles is substantially blocked.

2. A method as claimed in claim 1 wherein said displaying comprises illuminating a second, display spatial light modulator (SLM), and further comprising modulating one or more of an intensity of said illumination, an illumination time, a display time of said hologram on said SLM, and a shutter time of said shutter SLM, to compensate for coverage of a said tile by said image.

3. A method as claimed in claim 1 comprising displaying a plurality of holograms for each said tile sequentially in time such that they are perceived as a single time-averaged image of said tile.

4. A method as claimed in claim 1, wherein said image is displayed using display optics which form an intermediate image of said reply field, and wherein said shutter SLM is located at said intermediate image.

5. A method as claimed in claim 1 wherein said dividing comprises dividing into spatially overlapping tiles for tolerance of misalignment of between said shutter SLM and positions of said tiles in said replay field.

6. A method as claimed in claim 1 wherein said shutter SLM has pixels substantially spatially corresponding with said tiles.

7. A method as claimed in claim 1 further comprising calculating a said hologram for a said tile using a procedure configured to move noise outside a window defined by the tile.

8. A carrier carrying processor control code to, when running, implement the method of claim 1.

9. A holographic image display system, the system comprising:
a substantially coherent light source;
a display SLM to modulate light from said light source with a hologram;
display optics to form an image from said hologram, said display optics having an intermediate image position at which an image of a replay field of said hologram is formed; and
a shutter SLM at said intermediate image position to spatially filter light forming said displayed image.

10. A holographic image display system as claimed in claim 9 further comprising a control system configured to:
drive said display SLM to display said image by displaying each of a plurality of spatial tiles of said image in turn; and
control said shutter SLM to substantially block light from all of said plurality of spatial tiles except for said displayed tile as each said tile is displayed.

11. A holographic image display system as claimed in claim 10 wherein said spatial tiles overlap one another.

12. A holographic image display system as claimed in claim 10 wherein said control system is configured to drive said SLM with a plurality of holograms for each said spatial tile.

13. A holographic image display system as claimed in claim 12 wherein said control system is configured to calculate said holograms using an OSPR-type procedure.

14. A holographic image display system as claimed in claim 10 wherein said control system is configured to calculate a hologram for a said spatial tile by a procedure which moves noise outside a spatial window approximating said tile.

15. A holographic image display system as claimed in claim 9 wherein said shutter SLM comprises a transmissive ferroelectric liquid crystal (FLC) SLM.

16. A holographic image display system as claimed in claim 9 wherein said display SLM comprises a reflective FLC SLM.

17. A holographic image display system as claimed in claim 9 wherein said display optics comprise demagnifying optics.

18. A data processing system for driving the holographic image display system of claim 9, the system comprising:
an input to receive image data defining an image to be displayed;
a system for dividing said image into a plurality of spatial tiles:
a hologram data calculation system to calculate hologram data representing each of said tiles for display on said display SLM; and
a shutter control system for controlling said shutter SLM such that light for substantially only a single said tile is displayed at once.

19. A data processing system as claimed in claim 18 further comprising a modulation control system to modulate display of said tiles to compensate for varying coverage by said image of said tiles.

20. A data processing system for driving the holographic image display system of claim 9, the system comprising:
an input to receive image data defining an image to be displayed;
a system for dividing said image into a plurality of spatial tiles:
a hologram data calculation system to calculate hologram data representing each of said tiles for display on said display SLM; and
a modulation control system to modulate display of said tiles to compensate for varying coverage by said image of said tiles.
